(19) United States
(12) Patent Application Publication
(10) Pub. No.: US 2007/0153343 A1
(43) Pub. Date: Jul. 5, 2007

(54) Holographic sensor

(76) Inventors: Jeffrey Blyth, Cambridge (GB); Christopher Robin Lowe, Cambridge (DE); Colin Alexander Bennett Davidson, Cambridge (DE); Satyamoorthy Kabilan, Cambridge (DE); Catherine Anne Dobson, Cambridge (DE)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/565,094

(22) PCT Filed: Jul. 21, 2004
(86) PCT No.: PCT/GB04/03176

§ 371 Date: Jan. 16, 2007

(30) Foreign Application Priority Data
Jul. 21, 2003 (GB) 0317092.5
Jan. 8, 2004 (GB) 0400350.5

(51) Int. Cl. G02B 5/32

(52) U.S. Cl. 359/15

(57) ABSTRACT

A sensor (8) comprises a medium and a hologram disposed throughout the volume of the medium, wherein an optical characteristic of the hologram changes as a result of a variation of a physical property of the medium, and wherein the hologram is formed as a non-planar mirror.

### FIELD OF THE INVENTION

This invention relates to a holographic sensor.

### BACKGROUND TO THE INVENTION

WO-A-95/26499 discloses a holographic sensor. The sensor comprises a holographic support medium and, disposed throughout its volume, a hologram. The support medium interacts with an analyte, resulting in a variation of a physical property of the medium. This variation induces a change in an optical characteristic of the holographic element, such as its polarisability, reflectance, refractance or absorbance. If any change occurs whilst the hologram is being replayed (e.g. using incident broad band, non-ionising electromagnetic radiation), then a colour change, for example, may be observed using an optical detector. The optical detector may be a spectrometer or simply the human eye.

WO-A-99/63408 describes an alternative method of producing a holographic sensor. A sequential treatment technique is used, wherein the polymer film is made first and sensitive silver halide particles are added subsequently. These particles are introduced by diffusing soluble salts into the polymer matrix where they react to form an insoluble light-sensitive precipitate. The holographic image is then recorded.

The holographic sensors described above are made by recording a hologram using a plane mirror, which is holographed in a trough of suitable liquid. Furthermore, the support media of the sensors are planar. This arrangement may not always be effective if the sensor is to be used in an environment where there is considerable light scatter, e.g. subcutaneously. In addition, the optical detector must be placed at a particular position with respect to the sensor, in order to detect reflected light.

### SUMMARY OF THE INVENTION

The present invention is based on a realisation that the above problems can be addressed by forming the hologram as a non-planar mirror. This can be achieved in various ways, e.g. by recording the hologram using a non-planar mirror and using non-planar support media.

Accordingly, a first aspect of the invention is a sensor comprising a medium and, disposed therein, a hologram, wherein an optical characteristic of the hologram changes as a result of a variation of a physical property of the medium, and wherein the hologram is formed as a non-planar mirror.

A second aspect of the invention is a method for the production of a sensor of the invention, which comprises forming, in a medium, a hologram as a non-planar mirror.

Another aspect of the invention is a method for the detection of an analyte, which comprises remotely interrogating, with light, the holographic element of a sensor of the invention; and detecting any change in an optical characteristic of the sensor.

The invention allows for the design of holographic sensors which can reflect incident light in an accurate and predetermined fashion. The invention may obviate the requirement for the optical detector to be “brought” to the sensor. Indeed, the invention provides sensors which can be interrogated from a wider range of angles and distances. Sensors of the invention may be used as subcutaneous implants or in security, for example as authentication tags.

### BRIEF DESCRIPTION OF THE DRAWINGS

FIGS. 1 and 2 are schematic views showing how a sensor of the invention can be produced using, respectively, a concave mirror and a corner cube prism.

FIG. 3 is a side view of a probe suitable for interrogating a sensor of the invention.

FIG. 4 is a schematic diagram showing the sensor of FIG. 1 being interrogated.

FIG. 5 is the same as FIG. 4, except that the sensor is shown in a subcutaneous environment.

FIG. 6 is a plan view of an annular sensor of the invention, formed using a concave mirror.

FIG. 7 is a schematic diagram showing the sensor of FIG. 6 being interrogated.

FIGS. 8 and 9 are plan views of different embodiments of the invention, each sensor being suitable for the simultaneous detection of a plurality of analytes.

FIG. 10 is a ray diagram of a hologram formed as a concave mirror.

FIG. 11 is a schematic diagram showing a method of forming a sensor of the invention.

FIG. 12 is a graph showing the angular tolerance of a sensor of the invention.

### DESCRIPTION OF PREFERRED EMBODIMENTS

There are numerous ways in which the hologram can be formed as a non-planar planar mirror. It will be appreciated that the various techniques described in herein can be used alone or in combination, to achieve this effect.

A preferred embodiment of the invention involves recording the hologram using a non-planar mirror. The type of mirror selected will depend on the desired effect that the resulting hologram will have on incident light. Many different types of non-planar mirror are known, for example, concave and convex mirrors (e.g. semi-cylindrical mirrors), reflective beads and the like. Alternatively, the mirror may be a prism, for example a corner cube prism, a right angled prism, a Porro prism, an Amici prism, a Dove prism, a Penta prism, a rhomboid prism or a Lernan-Springer prism.

In a preferred embodiment, the mirror is a concave mirror. This allows for the production of a sensor which has a focusing effect on incident light. Such a sensor has a wide range of possible uses, for example as a small subcutaneous implant which can be conveniently interrogated using a fibre optic bundle. Furthermore, to overcome the major obstacle of the problem of light scatter, the replay wavelength range can be adjusted to extend well into the near infra-red. Another advantage associated with the use of a concave mirror is that unwanted specular white light is, in general, not focused by the hologram. Also, if observed from the opposite side, a concave hologram may have a convex mirror effect on incident light, and vice versa.

Another preferred embodiment involves the use of a convex mirror, to produce a hologram having an increased focal length and a collimating effect on incident light. An increased focal length is particularly desirable for applications where remote detection is required, for example the detection of an analyte in a fuel tank.

The non-planar mirror may be one capable of effecting retroreflection, such as a corner cube prism. Corner cube prisms typically reflect, up to a certain (“tolerance”) angle, any light entering the prism back towards the light source, regardless of the orientation of the prism. A hologram recorded using a corner cube prism may therefore have a retroreflecting effect on incident light. Such a sensor is advantageous because the optical detector does not need to be placed at a particular position with respect to the sensor. Another benefit associated with the use of a corner cube prism is that any response of the sensor can be viewed from a wider range of angles (i.e. a greater angular tolerance) than for a conventional sensor.

A retroreflecting holographic sensor may be used to detect changes in atmospheric conditions (e.g. humidity, temperature, levels of carbon dioxide or other chemically active gases) on a planet with an atmosphere. Detection may be achieved by interrogating the sensor with a collimated light beam or other remote light source. Such sensors may also be used to detect changes in underwater environments. For example, changes in the levels of pH or ions could be detected.

Alternatively, the non-planar mirror may consist of one or more reflective beads. Reflective beads can be used to increase the intensity of the reflected light and may also allow retroreflection.

It is preferred that the mirror is a dielectric material, since dielectric materials have a high reflective efficiency. Alternatively, a parabolic mirror may be used, to minimise the effects of chromatic and spherical aberration.

The hologram may be recorded in a non-planar support medium. In this case, the mirror need not necessarily be non-planar since the geometry of the support medium defines that of the hologram.

The hologram may be recorded using a lens and an aperture/obstacle, placed before the holographic recording material, during the recording process. When the hologram is recorded, radiation passes first through the lens and aperture/obstacle, and then the recording material, before reaching the mirror. The resulting hologram may, as a consequence, have a specific diffraction pattern. Such effects are desirable since they may result in a well-defined, specific pattern of replay light. Lenses may also be used to change the object size, collimate light or give a circular beam.

A holographic sensor of the type used in this invention generally comprises a holographic support medium and, disposed throughout the volume of the medium, a hologram. The support medium interacts with an analyte resulting in a variation of a physical property of the medium. This variation induces a change in an optical characteristic of the holographic element, such as its polarisability, reflectance, refractance or absorbance. If any change occurs whilst the hologram is being replayed by incident broad band, non-ionising electromagnetic radiation, then a colour or intensity change, for example, may be observed.

There are a number of basic ways to change a physical property, and thus vary an optical characteristic. The physical property that varies is preferably the size of the holographic element. This variation may be achieved by incorporating specific groups into the support matrix, where these groups undergo a conformational change upon interaction with the analyte, and cause an expansion or contraction of the support medium. Such a group is preferably the specific binding conjugate of an analyte species. Another way of changing the physical property to change the active water content of the support medium.

A holographic sensor may be used for detection of a variety of analytes, simply by modifying the composition of the support medium. The medium preferably comprises a polymer matrix, the composition of which must be optimised to obtain a high quality film, i.e. a film having a uniform matrix in which holographic fringes can be formed. The matrix may be formed from the copolymerisation of, say, (meth)acrylamide and/or (meth)acrylate-derived monomers, and may be cross-linked. In particular, the monomer HEMA (hydroxyethyl methacrylate) is readily polymerisable and cross-linkable. PolyHEMA is a versatile support material since it is swellable, hydrophilic and widely biocompatible.

Other examples of holographic support media are gelatin, K-carageenan, agar, agarose, polyvinyl alcohol (PVA), sol-gels (as broadly classified), hydro-gels (as broadly classified), and acrylates. Further materials are polysaccharides, proteins and proteinaceous materials, oligonucleotides, RNA, DNA, cellulose, cellulose acetate, polyamides, polyimides and polyacrylamides. Gelatin is a standard matrix material for supporting photosensitive species, such as silver halide grains. Gelatin can also be photo-cross-linked by chromium III ions, between carboxyl groups on gel strands.

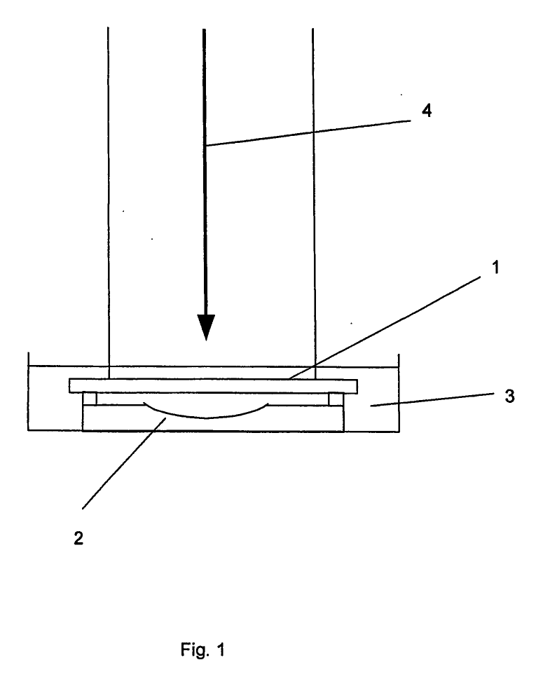

The sensor may be prepared according to the methods disclosed in WO-A-95/26499 and WO-A-99/63408. A suitable arrangement for this purpose is shown in FIG. 1 of the accompanying drawings. An alternative method is by silverless double polymerisation, as described in PCT/GB 04/00976. The contents of these specifications are incorporated herein by reference.

The invention will now be described by way of example only, with reference to the accompanying drawings.

FIG. 1 shows how a hologram may be formed as a curved concave mirror. A holographic plate 1 and a concave mirror 2 are present in an exposure bath 3. The holographic image is recorded using a spread laser beam 4. The term “concave” is used herein in a broad sense, to describe any arrangement that has a focusing effect. The mirror may be, for example, spheric, aspheric (e.g. parabolic) or it may comprise flat central and edge portions at an angle to each other. If such a mirror is made by the silverless double polymerisation method described above, there is normally no liquid in the exposure bath in FIG. 1.

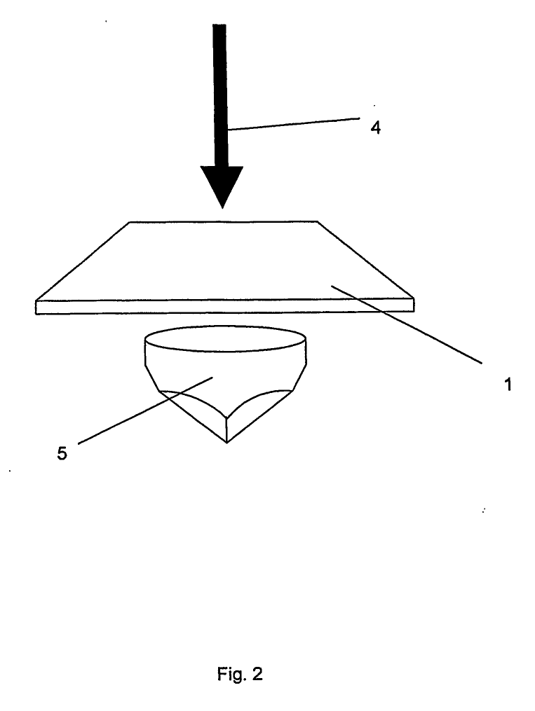

FIG. 2 shows a process similar to that of FIG. 1, except that a corner cube prism 5 is used, in place of the concave mirror.

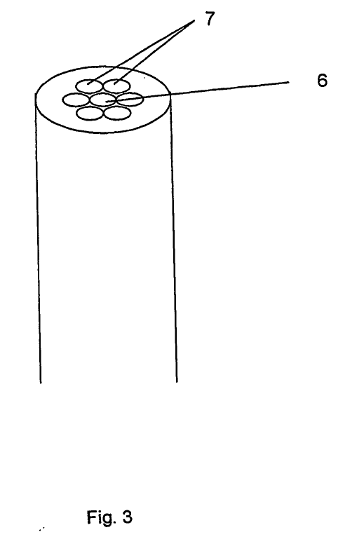

As indicated above, a sensor of the invention is particularly suitable for use in conjunction with a unit, e.g. of optical fibres, whereby light can be transmitted to and from the hologram. A suitable bundle of fibres, ending in a probe tip, is shown in FIG. 3. In a particular embodiment, the probe is about 5 mm in diameter, with an internal ring of six fibres, defining a circle 1 mm across, surrounding a central fibre.

In the particular embodiment shown in FIG. 3, the central fibre 6 leads to a spectrometer read-out (not shown) and the ring fibres 7 are connected to a white light illumination source (not shown). An alternative arrangement comprises optical fibres at the spectrometer end in a line, one above the other, to coincide with, or substitute for, the normal spectrometer slit.

Corner cube devices are such that, if the incident light is diverging, then the retroreflected lightwill continue to diverge, possibly resulting in a poor signal. Thus, it may be desirable to ensure that incident light is collimated or converged. In the case of the fibre optic arrangement of FIG. 3, this may be achieved by placing a small convex lens (not shown) in front of the bundle.

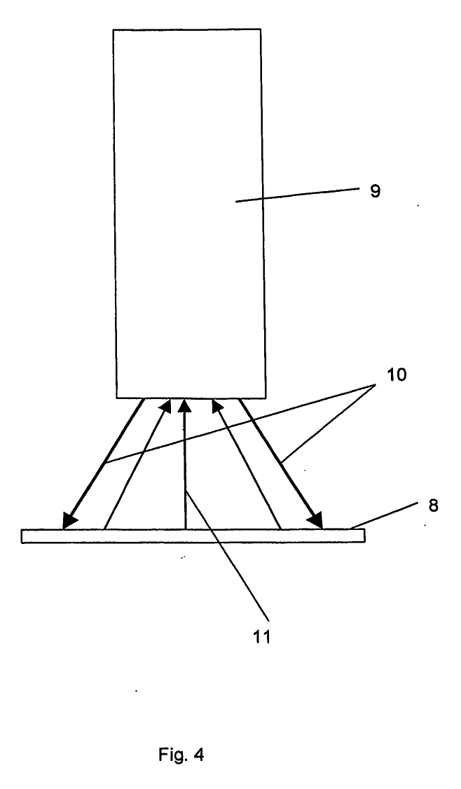

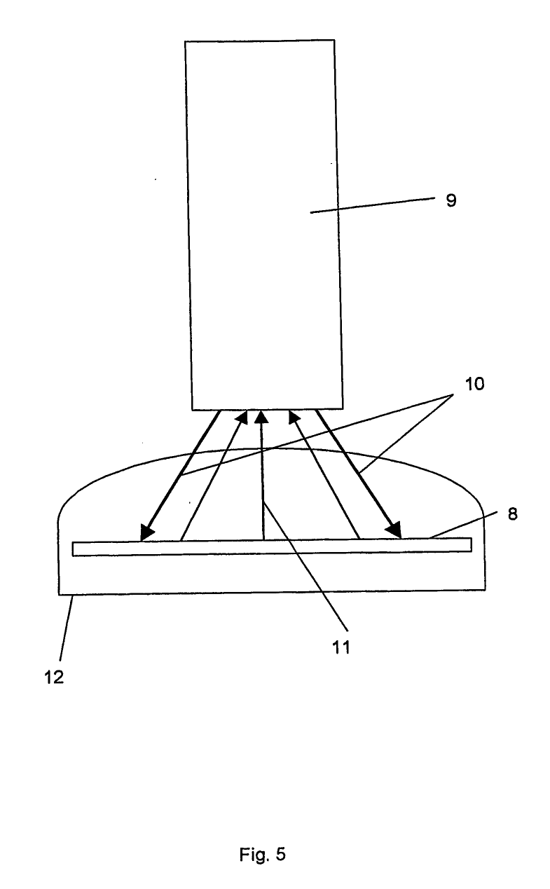

The utility of the invention will now be described, with particular reference to FIGS. 4 and 5.

In FIG. 4, a sensor 8 formed using a concave mirror (see, for example FIG. 1) is shown interrogated in a non-scattering clear environment, using a fibre optic bundle 9 as a probe. The hologram here returns the incident light 10 as if it were returning from the concave mirror used to make it. However, because it was made with a particular laser wavelength, it becomes in effect a monochromatic concave mirror. Furthermore, if made in a smart polymer, the colour of the reflected light 11 will change with its environment. An alternative is to make it with more than one, well-separated laser wavelength, enabling it to sense different factors in its environment. For example, it could appear to be simultaneously acting as a green, red or blue concave mirror, with the separation between the wavelengths much greater than the wavelength shifts likely to occur as it acts as a sensor, giving say a range of greens or reds but never large enough to cause ambiguous results from wavelength overlaps. The ability of the sensor to give a well-separated response to more than one analyte may be achieved using a sensor having a layered structure, each layer comprising a different material. Alternatively, the sensor may consist of different materials lying concentrically adjacent to each other throughout their depth.

The holographic concave mirror image focuses the coloured light onto the central fibre. A valuable feature of working on axis (unlike conventional techniques, where the diffracted light is arranged to reflect off at a slightly different angle to the specularly reflected light) is that, as the diffracted wavelength changes, it remains focused on the central position.

FIG. 5 shows the same arrangement of FIG. 4, but in a diffusing environment 12. This is typical of a subcutaneous implant.

In use, the intention is not necessarily to track changes in intensity of the returning light. If as much as 99% of the light is lost due to scatter, then being able to track a small wavelength shift in the remaining 1% from a very highly diffracting implanted smart hologram may be satisfactory. In order to reduce the problem of scattered light, it may sometimes be helpful to make the hologram with an off-axis concave mirror.

For use as an implant, the sensor may have to be covered with material to reduce rejection problems. This should not affect the detection of analytes found in the body, such as glucose or ions.

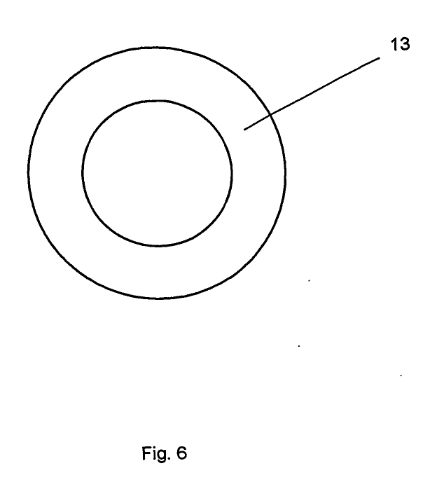

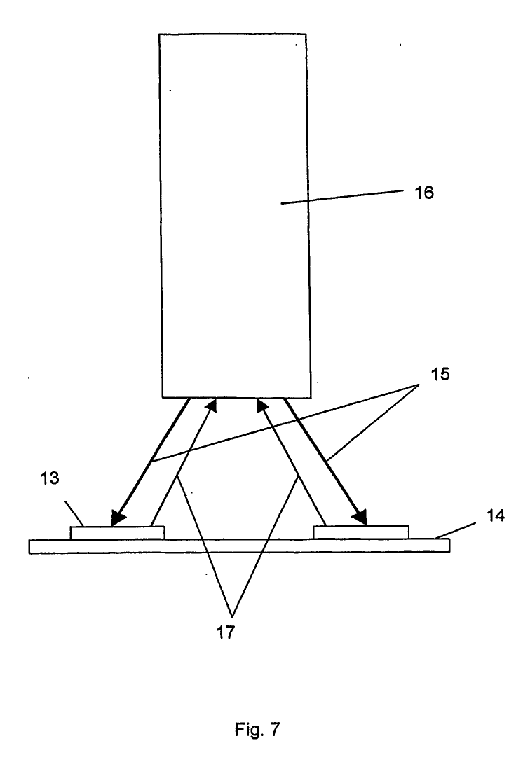

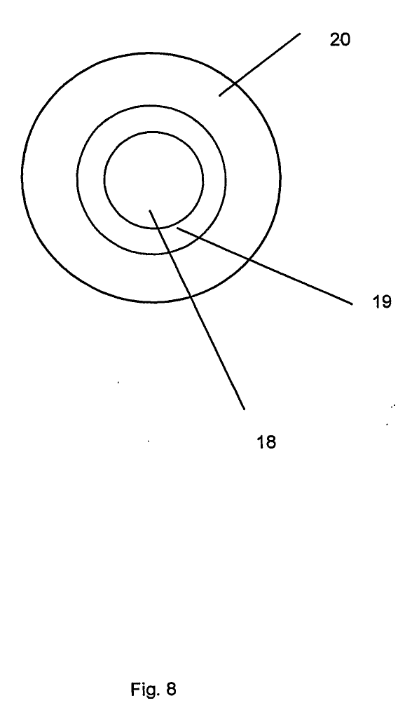

In a particular embodiment of the invention, a concave mirror sensor can have its centre removed or covered so that it is in the form of a ring. This is illustrated in FIGS. 6 and 7, the latter showing the sensor 13 being interrogated on a substrate 14. In this embodiment, provided that the light 15 provided by probe 16 is centred on the middle of the ring (i.e. as if the full concave mirror were present) and spreads sufficiently to cover its area, then the hologram will continue to focus quasi monochromatic light 17 to the centre, just as it would do for a full concave mirror image. Other embodiments of the invention are shown schematically in FIG. 8, where the concentric rings 18, 19, 20 illustrate an arrangement for the detection of a variety of analytes.

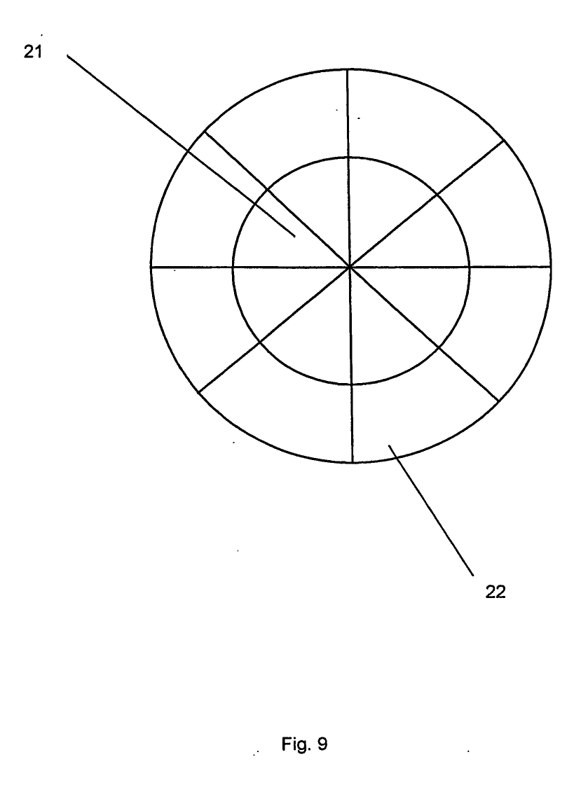

FIG. 9 shows a holographic sensor comprising two sections, 21 and 22, each comprising a hologram formed using a corner cube prism. Sections 21 and 22 can be used to detect a variety of different analytes. Both sections reflect incident light back to the light source (e.g. the fibre optic bundle illustrated herein), and thus the sensor may be used to detect two analytes simultaneously.

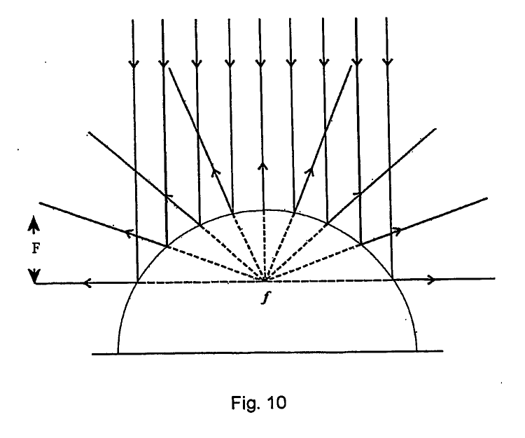

FIG. 10 is a ray diagram of a hologram recorded using a convex mirror. Use of a convex mirror of gradual curvature can allow for the production of a sensor having an increased focal length F and a collimating effect on incident light.

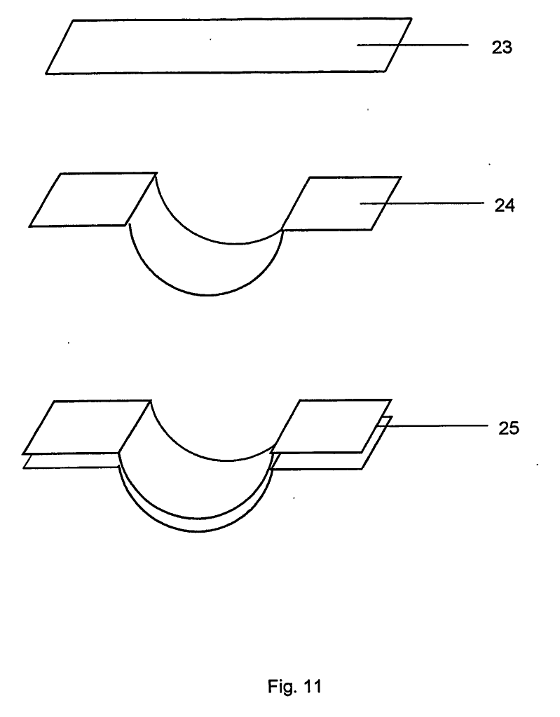

FIG. 11 shows how a sensor of the invention can be obtained by changing the geometry of the support medium after the hologram has been recorded. In FIG. 11, the planar sensor 23 is moulded into curved surface 24 to provide a sensor 25 (the sensor shown in contact with the curved surface) having a curved support medium and, as a result, a focal point of reflection. This method can be used for sensors having a hologram recorded using a planar or non-planar mirror. In the case of the latter, the focal point will be slightly off-centre.

The following Example illustrates the invention.

### EXAMPLE

A support medium was formed by polymerising a mixture of 60 mole % acrylamide, 30 mole % methacrylamide, 4.9 mole % methylene bisacrylamide, and 5.1 mole % 2-acrylamido-2-methyl-1-propanesulphonic acid. DMPA in DMSO (433 ml) was used per 0.1961 g of dry constituents. 100 μl of mixture was used per slide and polymerised for 30 minutes at 20.7° C.

AgNO₃(0.25 M, 400 ml) was then soaked into the polymer for 2 minutes, the excess wiped off and the slide dried for five minutes under a stream of warm air. The slide was then agitated for one minute using 4% (v/v) QBS dye in 1:1 methanol:water containing 4% KBr (v/v), and then rinsed in distilled water to remove excess bromide ions and any silver bromide remaining on the surface.

The slide was placed polymer side down in a dish containing two adjacent concave mirrors and a 60% ethanol (v/v) and water solution, and allowed to settle for five minutes. The holographic image of the two mirrors was then recorded using a laser.

The image was developed by using a 4:1 ratio of Saxby A: Saxby B developer, rinsing in deionised water, placing in a stop solution (5% acetic acid {v/v}) and rinsing in deionised water a final time. The slide was then placed in sodium thiosulphate and agitated for 5 minutes, to remove excess silver and QBS dye. The slide was then placed in methanol for around twenty minutes, to remove any remaining dye.

The hologram was observed using a probe, which consisted of a fibre optic bundle in conjunction with a 12.5 mm focal lens. The separation between the bundle and the lens was the same as that between the lens and the sensor, i.e. 25 mm. Observation was made using a rig which allowed the angle of viewing to be adjusted, at a constant probe distance. The peak diffraction wavelength was noted at each angle until the peak disappeared into background noise.

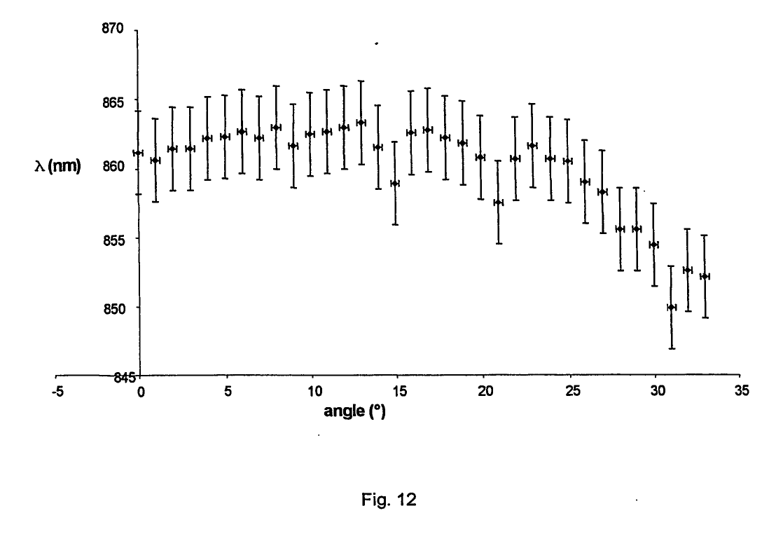

The results are shown in FIG. 12. The use of a concave mirror in the recording process meant that the response of the sensor was observed for a greater range of angles than for a conventional sensor.

1. A sensor comprising a medium and, disposed therein, a hologram, wherein an optical characteristic of the hologram changes as a result of a variation of a physical property of the medium, and wherein the hologram is formed as a non-planar mirror.

2. The sensor according to claim 1, wherein the hologram is formed as a concave mirror.

3. The sensor according to claim 1, wherein the hologram is formed as a convex mirror.

4. The sensor according to claim 1, wherein the hologram is formed as a corner cube prism.

5. A method for the production of a sensor comprising a medium and, disposed therein, a hologram, wherein an optical characteristic of the hologram changes as a result of a variation of a physical property of the medium, and wherein the hologram is formed as a non-planar mirror;
wherein said method comprises forming, in a medium, a hologram as a non-planar mirror.

6. The method according to claim 5, wherein the hologram is recorded in a non-planar medium.

7. The method according to claim 6, wherein the hologram is recorded using a planar mirror.

8. The method according to claim 5, wherein the hologram is recorded using a non-planar mirror.

9. The method according to claim 8, wherein the hologram is recorded using a concave mirror.

10. The method according to claim 8, wherein the hologram is recorded using a mirror capable of effecting retroreflection.

11. The method according to claim 10, wherein the hologram is recorded using a corner cube prism.

12. The method according to claim 8, wherein the hologram is recorded using one or more reflective beads.

13. The method according to claim 5, wherein the hologram is recorded using a lens, aperture, slit or obstacle, or a combination thereof, placed between the light source and the medium.

14. A method for the detection of an analyte, which comprises remotely interrogating, with light, the holographic element of a sensor comprising a medium and, disposed therein, a hologram, wherein an optical characteristic of the hologram changes as a result of a variation of a physical property of the medium, and wherein the hologram is formed as a non-planar mirror; wherein said method further comprises detecting any change in an optical characteristic of the sensor.

15. The method according to claim 14, wherein the light is collimated.
